(19) United States
(12) Patent Application Publication
(10) Pub. No.: US 2014/0223213 A1
(43) Pub. Date: Aug. 7, 2014

(54) MEMORY SYSTEM

(71) Applicant: Kabushiki Kaisha Toshiba, Minato-ku (JP)

(72) Inventors: Hajime YAMAZAKI, Kawasaki-shi (JP); Yousuke HARADA, Kawasaki-shi (JP); Hirokazu MORITA, Yokohama-shi (JP)

(21) Appl. No.: 13/919,179

(22) Filed: Jun. 17, 2013

Related U.S. Application Data
(60) Provisional application No. 61/760,768, filed on Feb. 5, 2013.

(51) Int. Cl. G06F 1/32; G06F 1/26

(52) U.S. Cl. CPC G06F 1/3268; G06F 1/266
USPC 713/324

(57) ABSTRACT

According to one embodiment, a memory system includes a nonvolatile memory, a controller configured to control an operation of the nonvolatile memory, a connector electrically connected to a host device, a power supply circuit configured to electrically connect the connector to the controller and the nonvolatile memory, and a power supply control circuit electrically connected to the connector and configured to control an operation of the power supply circuit in response to a first request sent from the host device. The power supply circuit cuts power supplies to the controller and the nonvolatile memory in response to the first request.

### CROSS-REFERENCE TO RELATED APPLICATIONS

This application claims the benefit of U.S. Provisional Application No. 61/760,768, filed Feb. 5, 2013, the entire contents of which are incorporated herein by reference.

### FIELD

Embodiments described herein relate generally to a memory system.

### BACKGROUND

A NAND flash memory is known as a type of nonvolatile semiconductor storage device. Furthermore, a storage device is known in which a NAND flash memory such as a solid-state drive (SSD) is mounted. A plurality of power supply management techniques has been proposed which is useful for reducing the power consumption of a storage device or a personal computer with a storage device mounted therein.

### BRIEF DESCRIPTION OF THE DRAWINGS

FIG. 1 is a block diagram of an SSD according to a first embodiment;

FIG. 2 is a block diagram showing an example of a storage controller shown in FIG. 1;

FIG. 3 is a circuit diagram showing an example of a power supply circuit shown in FIG. 1;

FIG. 4 is a diagram illustrating how the SSD operates in a first mode;

FIG. 5 is a diagram illustrating an operation of entering a second mode;

FIG. 6 is a diagram illustrating an operation of returning from the second mode;

FIG. 7 is a diagram illustrating signals between a power supply control circuit and a storage controller;

FIG. 8 is a diagram illustrating the contents of the plurality of signals shown in FIG. 7;

FIG. 9 is a timing chart showing an operation of the power supply control circuit entering the second mode;

FIG. 10 is a diagram illustrating a write operation of the storage controller;

FIG. 11 is a timing chart showing an operation of the power supply control circuit returning from the second mode;

FIG. 12 is a diagram showing a read operation of the storage controller;

FIG. 13 is a block diagram showing an example of configuration of a power supply circuit;

FIG. 14 is a block diagram of an SSD according to a second embodiment;

FIG. 15 is a block diagram showing an example of configuration of a power supply circuit;

FIG. 16 is a diagram illustrating a noise cancel operation according to a third embodiment;

FIG. 17 is a timing chart illustrating the noise cancel operation according to the third embodiment;

FIG. 18 is a diagram illustrating an operation of cancelling the second mode according to a fourth embodiment;

FIG. 19 is a timing chart illustrating the operation of canceling the second mode;

FIG. 20 is a timing chart illustrating a third mode operation of a host device according to a fifth embodiment;

FIG. 21 is a perspective view showing an example of a personal computer with the SSD mounted therein;

FIG. 22 is a bottom view showing the interior of main body of the personal computer;

FIG. 23 is a block diagram showing an example of system configuration of the personal computer with the SSD mounted therein; and

FIG. 24 is a schematic diagram showing a server with the SSD mounted therein.

### DETAILED DESCRIPTION

In general, according to one embodiment, a memory system comprises a nonvolatile memory, a controller configured to control operation of the nonvolatile memory, a connector electrically connected to a host device, a power supply circuit configured to electrically connect the connector to the controller and the nonvolatile memory, and a power supply control circuit electrically connected to the connector to control operation of the power supply circuit in response to a first request sent from the host device. The power supply control circuit sends a second request to the controller in response to the first request. The controller writes management information for management of the nonvolatile memory to the nonvolatile memory in response to the second request and then sends a first signal to the power supply control circuit. The power supply control circuit sends a third request to the power supply circuit in response to the first signal. The power supply circuit cuts power supplies to the controller and the nonvolatile memory in response to the third request.

Embodiments of the present invention will be described below with reference to the drawings. In the description below, components with the same functions and configurations are denoted by the same reference numerals. Duplicate descriptions are provided only when required.

### First Embodiment

### 1. Memory System Configuration

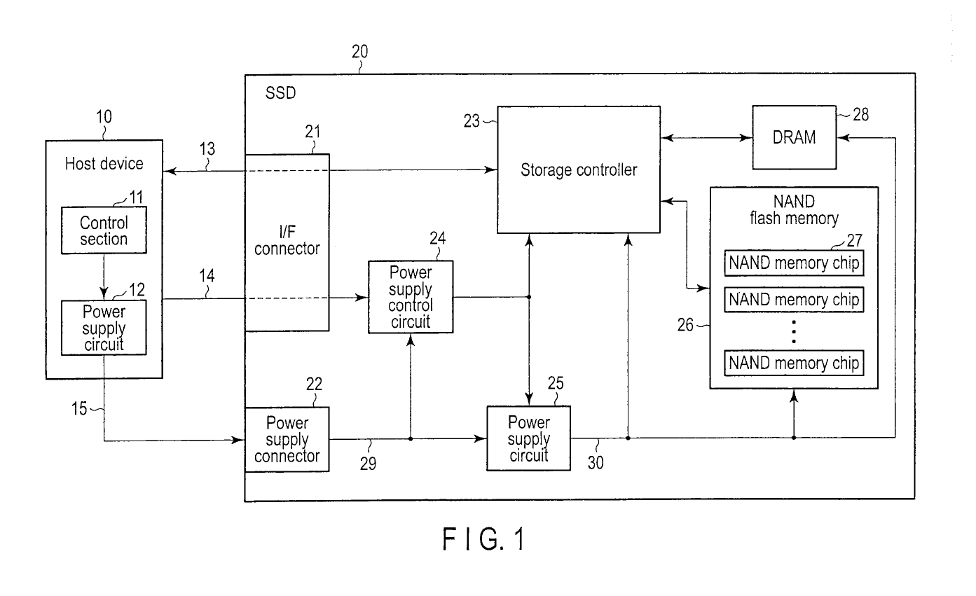

FIG. 1 is a block diagram of a memory system 20 according to a first embodiment. The memory system 20 comprises a nonvolatile semiconductor storage device 26. The nonvolatile semiconductor storage device 26 is a nonvolatile memory (non-transient memory) that prevents data therein from being lost even if a power supply thereto is cut. In the present embodiment, the nonvolatile semiconductor storage device 26 will be described taking a NAND flash memory as an example. Furthermore, a solid-state drive (SSD) will be described as an example of a storage device comprising a NAND flash memory as the memory system 20.

The SSD 20 is connected to a host device 10 (information processing device) via an interface and a power supply line. The host device 10 is an external device that writes and reads data to and from a storage device comprising a NAND flash memory. The host device 10 comprises, for example, one of a personal computer, a CPU core, and a server connected to a network, or a combination of any of these devices. The host device 10 comprises a control section 11 and a power supply circuit 12. The control section 11 controls different operations of the host device 10. The power supply circuit 12 controls power to be supplied to a power supply line (power line) electrically connected to modules in the host device 10 including the SSD 20. Furthermore, the host device 10 controls data accesses to the SSD 20, and sends, for example, a write request, a read request, and an erase request to the SSD 20 to write, read, and erase data to and from the SSD 20.

The SSD 20 comprises an interface connector (I/F connector) 21, a power supply connector 22, a storage controller 23, a power supply control circuit 24, a power supply circuit 25, a NAND flash memory 26, and a volatile memory 28. The storage controller 23, the NAND flash memory 26, and the volatile memory 28 are connected together via a bus.

The storage controller 23 integrally controls operation of the SSD 20. The storage controller 23 is connected to the host device 10 by an interface 13 via the interface connector 21. Examples of the interface 13 include Serial Advanced Technology Attachment (SATA), Peripheral Component Interconnect Express (PCIe), Serial Attached SCSI (SAS), and Universal Serial Bus (USB). According to the present embodiment; for example, SATA is used as the interface 13.

The volatile memory 28 comprises, for example, a DRAM. The DRAM 28 is used as a storage section for data transfer and management information recording and for use as a work area. Specifically, as a storage section for data transfer (data transfer buffer), the volatile memory 28 temporarily stores write data sent from the host device 10 before the data is written to the NAND flash memory 26 and temporarily stores read data read from the NAND flash memory 26 before the data is sent to the host device 10. Furthermore, as a storage section for management information recording, the volatile memory 28 is used to store management information for the NAND flash memory 26 (information that allows management of positions in the NAND flash memory 26 where data is stored and information that allows management of the status of a storage region in the NAND flash memory 26).

The power supply connector 22 is electrically connected to the power supply circuit 12 in the host device 10 via a power supply line 15. The power supply connector 22 receives different levels of power (supply of electricity with different voltage levels) for the SSD 20 from the host device 10. The power supply circuit 12 in the SSD 20 is electrically connected to the power supply connector 22 via a power supply line 29 and also electrically connected to the storage controller 23, the NAND flash memory 26, and the DRAM 28 via a power supply line 30. The power supply circuit 25 receives different levels of power from the power supply connector 22 and distributes the power to the storage controller 23, the NAND flash memory 26, and the DRAM 28.

The power supply control circuit 24 is electrically connected to the power supply connector 22 via the power supply line 29 and also electrically connected to the host device 10 via a signal line 14. The power supply control circuit 24 controls the operation of the power supply circuit 25 and the storage controller 23 based on signals sent from the host device 10 via the signal line.

The NAND flash memory 26 stores user data managed by the host device 10 and stores management information managed by the DRAM 28 for backup. The NAND flash memory 26 comprises, for example, a plurality of NAND memory chips. Each of the NAND memory chips 27 includes a memory cell array with a plurality of memory cells arranged in a matrix. The memory cell array comprises a plurality of physical blocks arranged therein and corresponding to data erase units. The NAND flash memory 26 writes and reads data to and from each physical page. The physical block is formed of a plurality of physical pages.

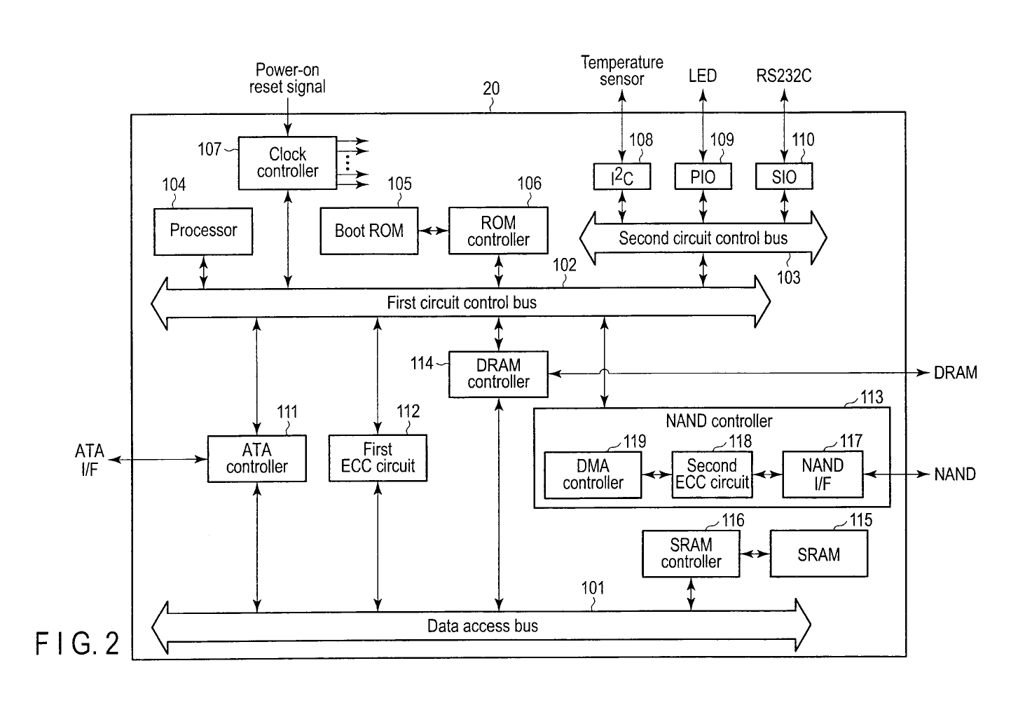

FIG. 2 is a block diagram showing an example of the storage controller 23 shown in FIG. 1. The storage controller 23 comprises a data access but 101, a first circuit control bus 102, and a second circuit control bus 103. A processor 104 that controls the whole storage controller 23 is connected to the first circuit control bus 102. A boot ROM 105 is connected to the first circuit control bus 102 via a ROM controller 106. A boot program that boots each management program (firmware (FW)) stored in the NAND memory 20 is stored in the boot ROM 105.

Furthermore, a clock controller 107 is connected to the first circuit control bus 102. The clock controller 107 receives a power on reset signal from the power supply circuit 25 shown in FIG. 2 to supply a reset signal and a clock signal to each section.

The second circuit control bus 103 is connected to the first circuit control bus 102. The second circuit control bus 103 connects to an I²C circuit 108 for receiving data from a temperature sensor, a parallel IO (PIO) circuit 109 that supplies a status display signal to a status display LED, and a serial IO (SIO) circuit 110 that controls an RS232C interface.

An ATA interface controller (ATA controller) 111, a first error checking and correcting (ECC) circuit 112, a NAND controller 113 for the NAND flash memory 26, and a DRAM controller 114 are connected to both the data access bus 101 and the first circuit control bus 102. The ATA controller 111 sends and receives data to and from the host device 10 via the ATA interface 13. An SRAM 115 for use as a data work area and a firmware expansion area is connected to the data access bus 101 via an SRAM controller 116. When activated, firmware stored in the NAND flash memory 26 is transferred to the SRAM 115 by a boot program stored in the boot ROM 105.

The NAND controller 113 comprises a NAND interface 117, a second ECC circuit 118, and a DMA controller 119 for DMA transfer control. The NAND interface 117 carries out interface processing with the NAND flash memory 26. The DMA controller 119 for DMA transfer control controls accesses between the NAND flash memory 26 and the DRAM 28. The second ECC circuit 118 encodes a second error correcting code and also encodes and decodes a first error correcting code. The first ECC circuit 112 decodes the second error correcting code. The first error correcting code and the second error correcting code are, for example, Hamming codes, Bose Chaudhuri Hocgenghem (BCH) codes, Reed Solomon (RS) codes, or low-density parity check (LDPC) codes. The second error correcting code is assumed to have a higher correcting capability than the first error correcting code.

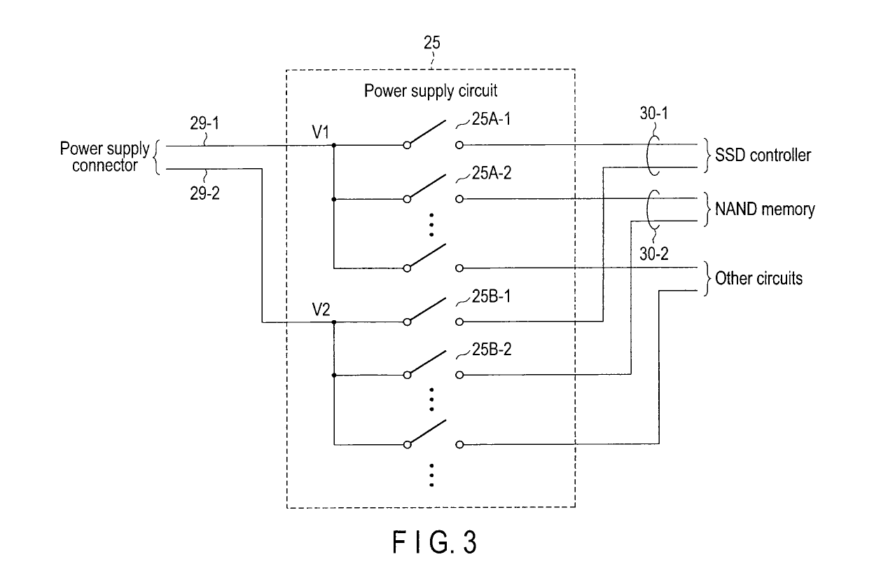

FIG. 3 is a circuit diagram showing an example of a switch unit included in the power supply circuit 25 shown in FIG. 1. The power supply circuit 25 comprises a plurality of switch elements (including 25A and 25B). The switch elements are controllably turned on and off to distribute different levels of power to the storage controller 23, the NAND flash memory 26, the DRAM 28, and the like.

The power supply circuit 25 receives a plurality of levels of power (including power V1 and power V2) from the host device 10. The power supply circuit 25 is supplied with the power V1 via a power supply line 29-1 and with the power V2 via a power supply line 29-2. The power supply line 29-1 is connected to first ends of the plurality of switch elements 25A (including 25A-1 and 25A-2). The power supply line 29-2 is connected to first ends of the plurality of switch elements 25B (including 25B-1 and 25B-2). Seconds ends of the switch elements 25A-1 and 25B-1 are connected to the storage controller 23 via power supply lines 30-1. Seconds ends of the switch elements 25A-2 and 25B-2 are connected to the NAND flash memory 26 via power supply lines 30-2.

### 2. Operation of the SSD 20

The operation of the SSD 20 configured as described above will be described. The SSD 20 is used in a first mode (normal mode or active mode) in which, in response to a request from the host device 10, the SSD 20 performs a data write operation, a data read operation, a data erase operation, or the like and in a second mode (power saving mode) which consumes less power than the first mode. The first mode enables a data transfer operation to be performed between, for example, the host device 10 and the SSD 20. In the first mode, in response to a request from the host device 10, the SSD 20 performs a data write operation, a data read operation, or a data erase operation. The consumption of less power means that an area to which power is supplied is smaller than in the first mode or that the SSD 20 operates with a clock frequency lower than a clock frequency in the first mode.

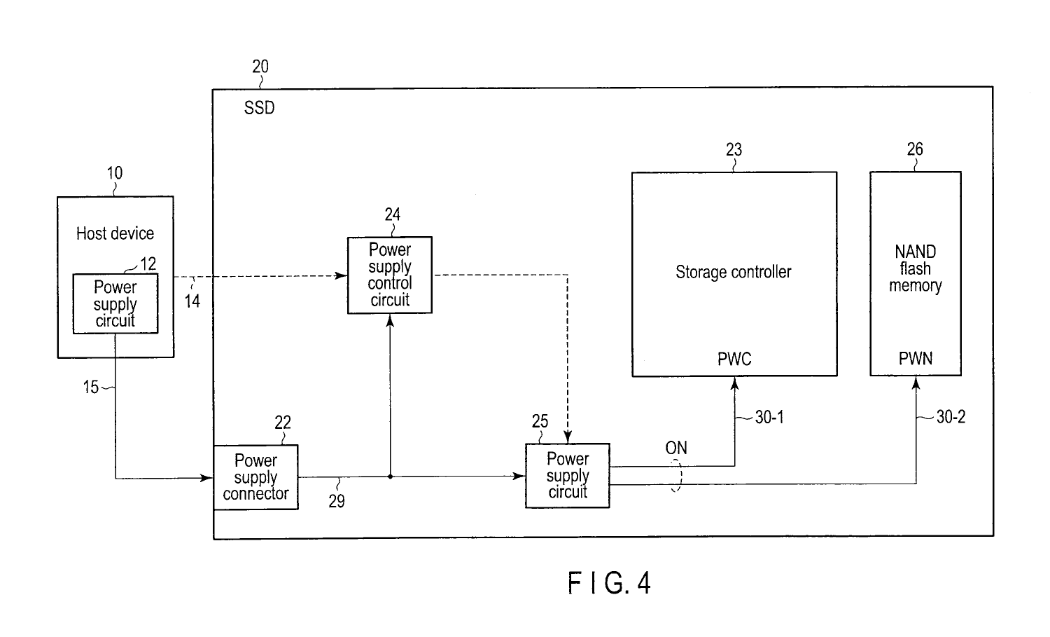

The second mode is a state in which the data transfer operation is stopped between the host device 10 and the SSD 20 and includes an inactive state of the SSD 20 (the state in which no current is passed through the SSD 20). In particular, in the second mode, the supply of power to the storage controller 23, the NAND flash memory 26, and the DRAM 28 is cut, according to the present embodiment. FIG. 4 is a diagram illustrating how the SSD 20 operates in the first mode. FIG. 4 shows extracted circuits required to describe the second mode according to the present embodiment. Furthermore, in the second mode, an operation of controlling the DRAM 28 is the same as the operation of controlling the NAND flash memory 26, and thus the DRAM 28 is not shown in FIG. 4.

In the first mode, the power supply connector 22 supplies power to the power supply control circuit 24 and the power supply circuit 25, and the power supply circuit 25 supplies power to the storage controller 23 and the NAND flash memory 26. Specifically, the power supply circuit 25 supplies power to a power supply terminal PWC of the storage controller 23 via the power supply line 30-1. Furthermore, the power supply circuit 25 supplies power to a power supply terminal PWN of the NAND flash memory 26 via the power supply line 30-2. Thus, the storage controller 23 and the NAND flash memory 26 can perform normal operations. The SSD 20 performs operations in accordance with requests from the host device 10 (including a write request, a read request, and an erase request). In actuality, the power supply line 30-1 includes a plurality of power supply lines corresponding to the different power supplies. However, for avoidance of complication of the drawings, the single power supply line 30-1 is shown in FIG. 4. This also applies to the power supply line 30-2.

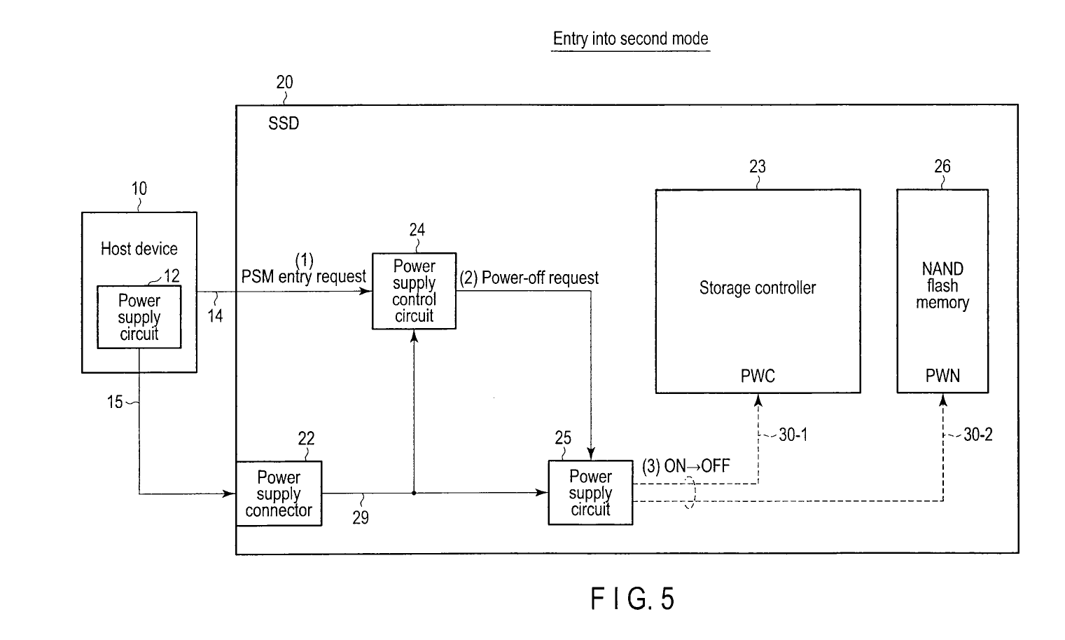

FIG. 5 is a diagram illustrating an operation of entering the second mode. First, the host device 10 sends a second mode (PSM) entry request to the power supply control circuit 24 of the SSD 20 via signal line 14. The power supply control circuit 24 sends a first power control request to the power supply circuit 25 in response to the PSM entry request. In response to the first power control request, the power supply circuit 25 controls the supply of power to the storage controller 23 and the NAND flash memory 26. As a result, the SSD 20 enters the second mode, which corresponds to a first power saving state in which power supplies to the storage controller 23 and the NAND flash memory 26 are limited. In the state in which the power supply is limited, a power supply route from the power supply is shut off or power fails to be sufficiently supplied which is required to allow functional components such as the storage controller 23 and the NAND flash memory 26 to function normally.

For simplification of description, the present embodiment takes the following form of operation as an example: in accordance with the first power control request, the power supply circuit 25 turns off the power supplies to the storage controller 23 and the NAND flash memory 26.

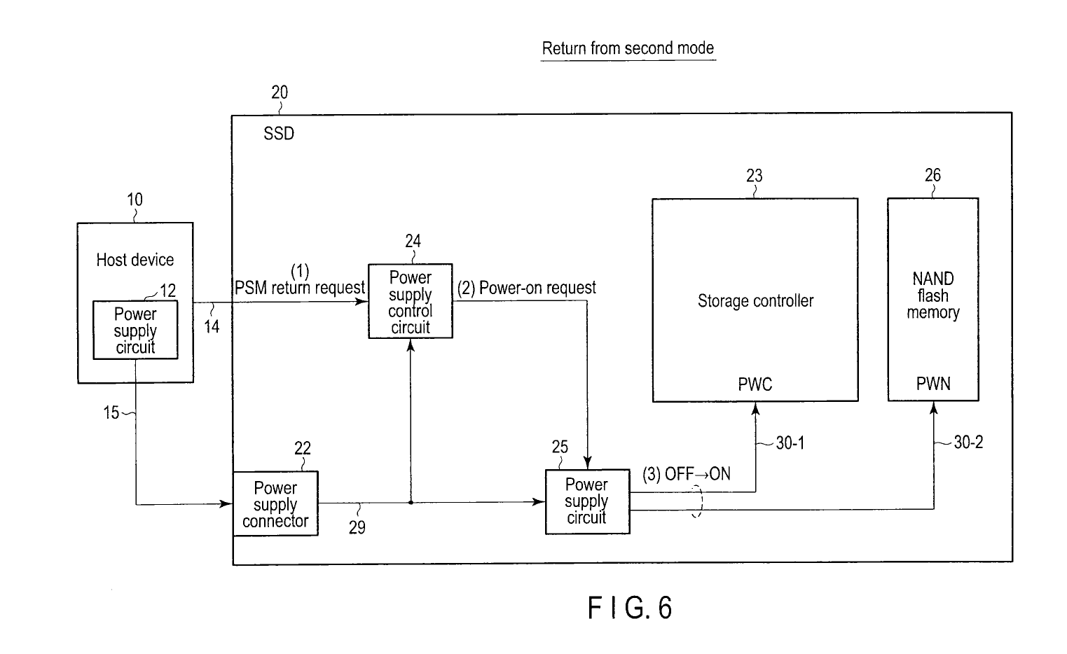

FIG. 6 is a diagram illustrating an operation of returning from the second mode. First, the host device 10 sends a second mode (PSM) return request to the power supply control circuit 24 of the SSD 20 via signal line 14. In response to the PSM return request, the power supply control circuit 24 sends a second power control request to the power supply circuit 25. In response to the second power control request, the power supply circuit 25 increases the power reduced in accordance with the first power control request so that the increased power is supplied to the storage controller 23 and the NAND flash memory 26 (the power supply is resumed in an off state). As a result, the SSD 20 returns from the second mode (that is, the SSD 20 changes from the second mode to the first mode). The storage controller 23 and the NAND flash memory 26 carry out the same initialization process as that executed when, for example, the SSD 20 is powered on, and then return to a state in which the storage controller 23 and the NAND flash memory 26 can perform a data transfer operation.

The power supply control circuit 24 receives power supply directly from the power supply connector 22, and can thus operate in response to a request from the host device 10 even in the second mode. Similarly, the power supply circuit 25 receives power supply directly from the power supply connector 22, and can thus operate in response to a request from the power supply control circuit 24 even in the second mode. Here, the state in which “the power supply circuit 25 receives power supply directly from the power supply connector 22” indicates that, for example, between the power supply control circuit 24 and the power supply connector 22, no component or mechanism is present which significantly affects the power supply or which limits or hinders requests from the host device 10. If the power supply control circuit 24 can operate in the second mode in response to a request from the host device 10, another component or mechanism may be present between the power supply control circuit 24 and the power supply connector 22.

### 3. Example of the Power Supply Control Circuit 24

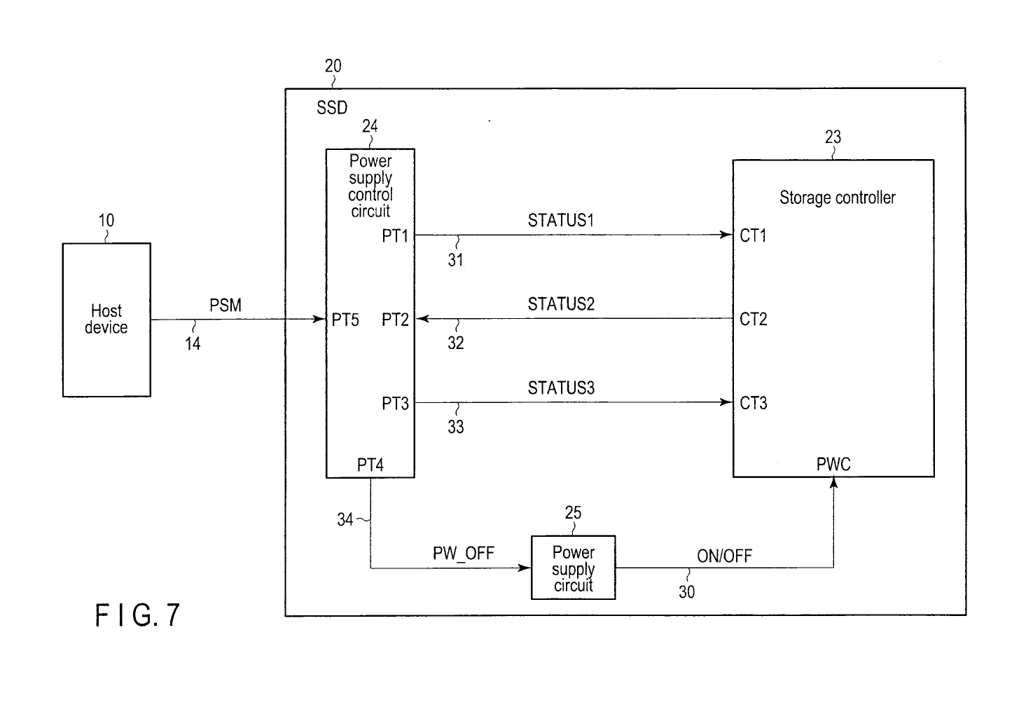

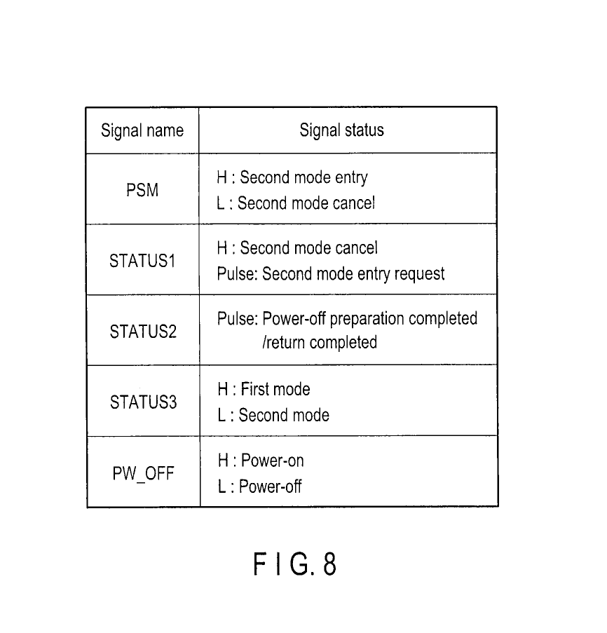

Now, a specific example of the power supply control circuit 24 in the second mode will be described. FIG. 7 is a diagram illustrating signals between the power supply control circuit 24 and the storage controller 23. FIG. 8 is a diagram illustrating the contents of the plurality of signals shown in FIG. 7.

The power supply control circuit 24 and the storage controller 23 are electrically connected together by a signal line 31 for a signal STATUS', a signal line 32 for a signal STATUS2, and a signal line 33 for a signal STATUS3. Signal line 31 electrically connects a terminal PT1 of the power supply control circuit 24 to a terminal CT1 of the storage controller 23. Signal line 32 electrically connects a terminal PT2 of the power supply control circuit 24 to a terminal CT2 of the storage controller 23. Signal line 33 electrically connects a terminal PT3 of the power supply control circuit 24 to a terminal CT3 of the storage controller 23. The power supply control circuit 24 and the power supply circuit 25 are electrically connected together by a signal line 34 for a signal PW_OFF. One end of signal line 34 is connected to a terminal PT4 of the power supply control circuit 24. The power supply control circuit 24 and the host device 10 are electrically connected together by a signal line 14 for a signal PSM. One end of signal line 14 is connected to a terminal PT5 of the power supply control circuit 24.

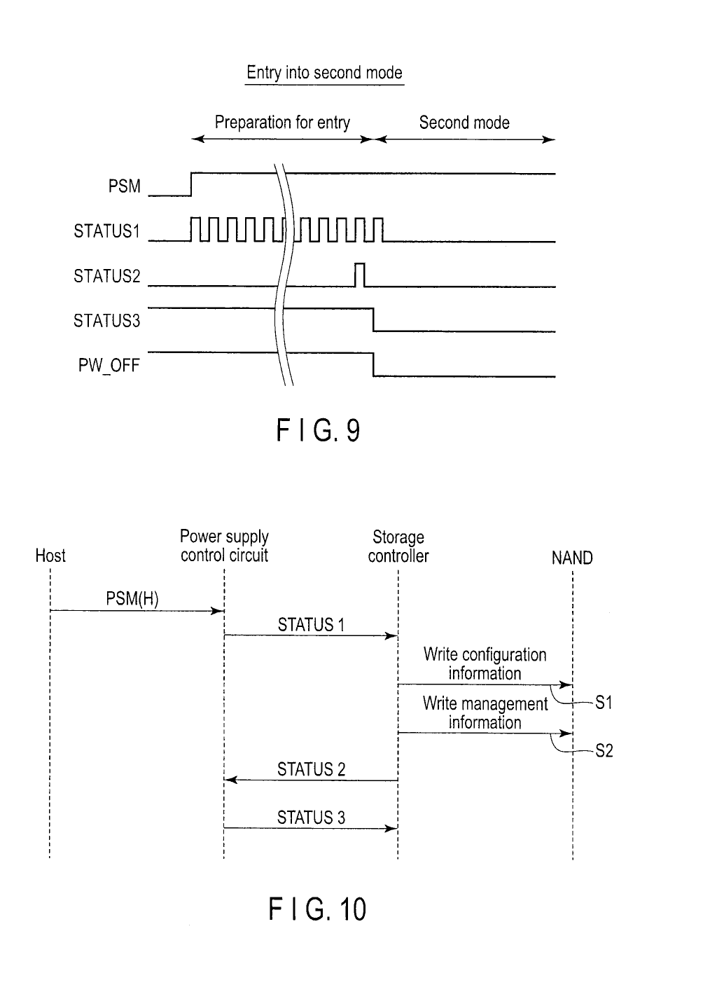

FIG. 9 is a timing chart showing an operation of the power supply control circuit 24 entering the second mode. First, the host device 10 sets signal PSM to a high level (a second level higher than a first level) in order to enter the second mode.

In response to signal PSM at the high level, the power supply control circuit 24 outputs a continuous pulse as signal STATUS1. In response to signal STATUS1 comprising the continuous pulse, the storage controller 23 executes a preparation process for power-off (disconnection or reduction of the power supply). Specifically, during the preparation process, the storage controller 23 writes information on the configuration of the SSD 20 which is present immediately before the second mode is entered, to the NAND flash memory 26 as shown in FIG. 10 (step S1). The configuration information is set in the SSD 20 by the host device 10 via an interface and includes, for example, security information, partition information, and information on power supply management. Moreover, during the preparation process, the storage controller 23 writes management information loaded from the NAND flash memory 26 into a volatile area (including the DRAM 28), to the NAND flash memory 23. The management information includes a management table that allows management of the correspondence between the logical address and physical address of data stored in the NAND flash memory 26, and information for management of the status of the storage area in the NAND flash memory 26 (the number of block erasures, the number of block rewrites, information indicating whether or not the block is empty, and defective-block information).

Volatile data stored in the volatile area includes a power-on time and temperature history data. The volatile data is measured and updated in the SSD 20. Given that the volatile data is written to the NAND flash memory 26 when the second mode is entered, the NAND flash memory 26 is fatigued if entry and return of the second mode are repeated. Thus, the present embodiment prevents the volatile data from being written to the volatile area when the second mode is entered. Such control reduces the number of rewrites in the NAND flash memory 26 and thus the fatigue of the NAND flash memory 26. Thus, when the SSD 20 returns from the second mode, the status of the SSD 20 temporarily returns by an amount equivalent to the amount of lost volatile data. The present embodiment is not limited to such control, and the volatile data may be written to the NAND flash memory 26 when the second mode is entered.

When the preparation process for power-off is completed, the storage controller 23 outputs a pulse as signal STATUS2. In response to signal STATUS2 comprising the pulse, the power supply control circuit 24 sets both signal STATUS3 and signal PW_OFF to a low level (a third level lower than the first level). In response to signal PW_OFF at the low level, the power supply circuit 25 controls the power supply to the storage controller 23 (and the NAND flash memory 26). As a result, the first power saving state is implemented in the SSD 20.

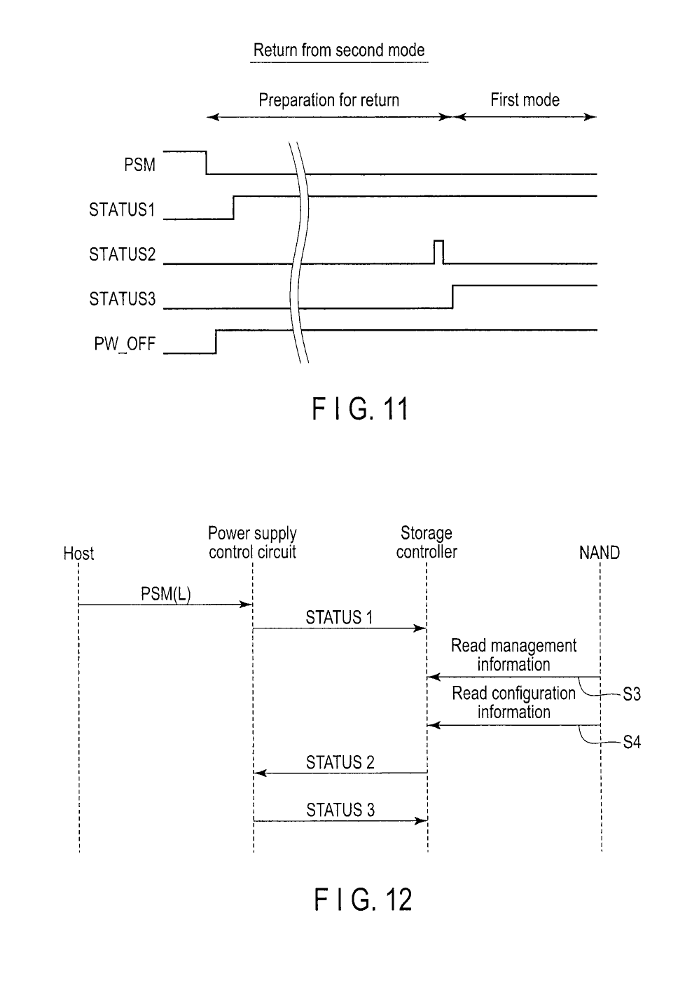

FIG. 11 is a timing chart of an operation of the power supply control circuit 24 retuning from the second mode. First, to return from the second mode, the host device 10 sets signal PSM to the low level.

In response to signal PSM at the low-level, the power supply control circuit 24 sets signal PW_OFF to the high level and subsequently sets signal STATUS1 to the high level. In response to signal PW_OFF at the high level, the power supply circuit 25 starts supplying power to the storage controller 23 (and the NAND flash memory 26). The storage controller 23 confirms that signal STATUS1 is at the high level to determine that this power-on is to return from the second mode. As a result, the storage controller 23 (and the NAND flash memory 26) is made operative. Then, the storage controller 23 carries out a return process (activation process). The return process includes resetting (initialization) of circuits in the storage controller 23, resetting of the NAND flash memory 26, and resetting of the DRAM 28. Furthermore, as shown in FIG. 12, the storage controller 23 reads management information from the NAND flash memory 26 (step S3) and expands the management information into the DRAM 28. Moreover, during the return process, the storage controller 23 reads the configuration information on the SSD 20 from the NAND flash memory 26 (step S3). The use of the configuration information enables the SSD 20 to return to a status set before the second mode.

An increase in the speed of an activation process carried out by the storage controller 23 enables a reduction in time required to return from the second mode. Techniques for increasing the speed of the activation process carried out by the storage controller 23 are as follows.

(1) While the NAND flash memory 26 is being reset (initialized), firmware processing requiring no NAND access is carried out in parallel. As the firmware processing requiring no NAND access, resetting of the DRAM or the SRAM is executed while the NAND flash memory 26 is being reset.

(2) While system data for activation is being read from the NAND flash memory 26, firmware processing independent of read data is carried out.

(3) A plurality of NAND memory chips 27 is reset in parallel.

When the return from power-off is completed, the storage controller 23 outputs a pulse as signal STATUS2. In response to signal STATUS2 comprising the pulse, the power supply control circuit 24 sets signal STATUS3 to the high level. Based on signal STATUS3 at the high level, the storage controller 23 determines that the first mode has been entered.

### 4. Example of Configuration of the Power Supply Circuit 25

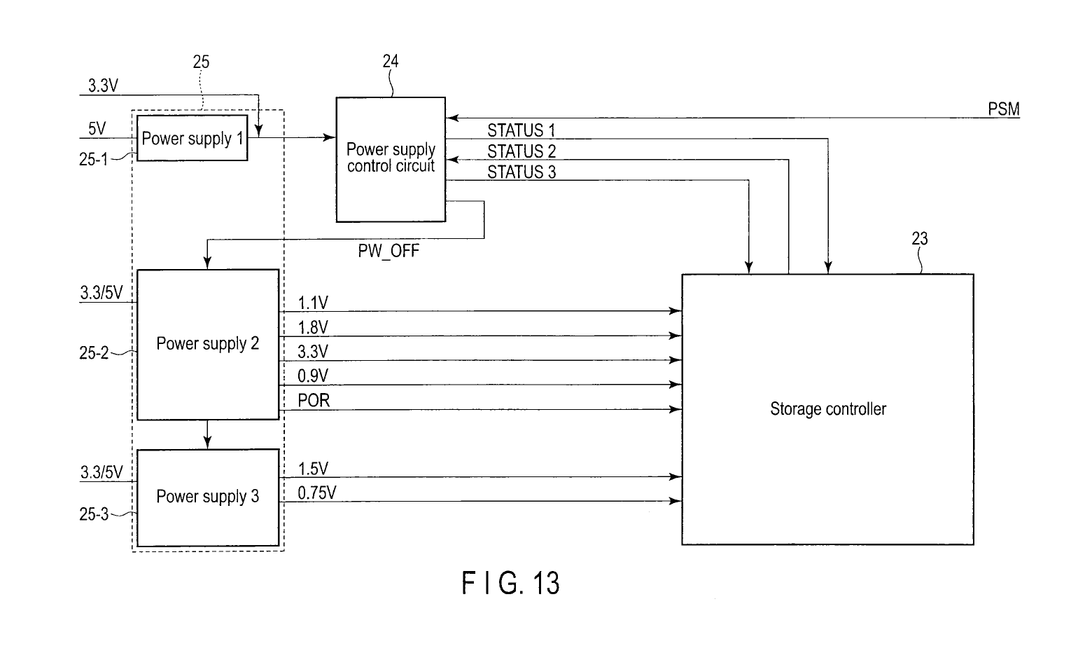

FIG. 13 is a block diagram of an example of configuration of the power supply circuit 25. The power supply circuit 25 comprises a first power supply (power supply 1) 25-1, a second power supply (power supply 2) 25-2, and a third power supply (power supply 3) 25-3. The first power supply 25-1 supplies different levels of power to the power supply control circuit 24. The second power supply 25-2 supplies different levels of power to the storage controller 23, and supplies a power-on reset signal POR to the storage controller 23. In response to the power-on reset signal POR, the storage controller 23 performs a reset operation. The third power supply 25-3 supplies power for the DRAM to the storage controller 23.

As described above, upon receiving a request for power saving from the host device 10, the power supply control circuit 24 and the power supply circuit 25 can control the power supplies to the storage controller 23, the NAND flash memory 26 and the DRAM 28 according to the first embodiment. This enables a reduction in the power consumption of the SSD 20 and in the total power consumption of an external device such as the host device electrically connected to the SSD 20.

For example, a personal computer taken as an example of the host device has an idle mode, a standby mode, a rest mode (rest status), and a sleep mode as power saving modes that reduce power consumption. The idle mode corresponds to a second power saving state in which power supplies to modules and units such as a display are partly reduced which modules and units are included in the host device and are not used because the host device is being started up. In the standby mode, the host device itself is in a third power saving state (in which the consumption of power other than power for holding data in the memory in the host device is reduced) so that data being processed remains stored in the memory in the host device. In the rest mode, with data being processed stored in an external storage device (which appears external to the host device) such as the SSD 20 or a hard disk drive, the host device is in a fourth power saving state (the third power saving state in which the consumption of the power including the power for holding data in the memory is reduced). The sleep mode is a combination of the standby mode and the rest mode and is such that with work data stored in both the memory and the external storage device, the host device is in the third power saving mode. The idle mode, the standby mode, the sleep mode, and the rest mode are differentiated from one another in terms of power consumption, time required to enter each of the modes, and time required to return from each of the modes. The power consumption decreases in the following order: the idle mode, the standby mode, the sleep mode, the rest mode, and a state in which a driving power supply to the host device is completely shut down. The power consumption can be reduced by a technique for reducing circuits that apply the power supply voltage, delaying a dynamic clock, or the like. The time required to enter each mode and the time required to return from each mode increase in the following order: the idle mode, the standby mode, the sleep mode, the rest mode, and the state in which the driving power supply to the host device is completely shut down.

Thus, the present embodiment can provide, in addition to, for example, the power saving mode included in the host device itself, various power saving modes conforming to the user's usage environment. This enables the user's convenience to be improved. For example, the present embodiment can create not only a plurality of power saving states that can be configured and manipulated by the host device but also the above-described first power saving state. Specifically, if the user is using the host device without using the SSD 20, for example, the user views a DVD or television broadcasting on the host device or is allowing another external storage device additionally added to the host device to function, none of the idle mode, the standby mode, the sleep mode, and the rest mode functions. However, the power consumed by the SSD 20 alone can be decreased, and the total power consumption of both the SSD 20 and the host device can be reduced.

Furthermore, power saving effects more compatible with the user's usage environment can be exerted by, for example, making settings such that the power saving mode of the SSD 20 is activated earlier than the power saving mode of the host device. Specifically, settings can be made such that if detection means (not shown in the drawings) in the host device detects that the host device has not been used for a first predetermined time after activation, the host device automatically enters one of the idle mode, the standby mode, the sleep mode, and the rest mode. However, settings can be made such that, in accordance with the settings made by the host device, the SSD 20 according to the present embodiment starts preparing for entry into the power saving mode of the SSD 20 before entry into each mode set by the host device (after the elapse of a second predetermined time shorter than the first predetermined time). This enables entry into the power saving mode of the SSD 20 to be facilitated.

Furthermore, return from the power saving mode of the SSD 20 can be timed to coincide with return from the power saving mode of the host device. For example, the following configurations are possible. That is, when returning from the power saving mode, the host device sends a second mode (PSM) return request to the power supply control circuit 24 in the SSD 20. Alternatively, means for detecting return of the host device from the power saving mode is provided in the SSD 20 so that when the host device returns from the power saving mode, the power supply control circuit 24 sends a second power control request to the power supply circuit 25. Such configurations enable the return of the SSD 20 from the power saving mode to be timed to coincide with the return of the host device from the power saving mode. This allows the user's convenience to be improved.

Furthermore, in the SSD 20 according to the present embodiment, the power supply control circuit 24 gives the storage controller 23 an advance notice of power control (power-off). Thus, the storage controller 23 can execute a preparation process for power control (power-off). That is, the storage controller 23 can write management information expanded into the DRAM 28 back to the NAND flash memory 26. Hence, even after return from the second mode, the storage controller 23 can be operated normally.

Additionally, the power supply control circuit 24 sends a signal indicating whether the current power-on corresponds to the return from the second mode or the power-on of the SSD 20, to the storage controller 23. Thus, the storage controller 23 can determine whether the current power-on corresponds to the return from the second mode or the power-on of the SSD 20.

### Second Embodiment

According to the first embodiment, the storage controller 23 and the power supply control circuit 24 are configured using respective individual IC chips, and the two IC chips are connected together by terminals and signal lines. According to a second embodiment, the power supply control circuit 24 is incorporated into the storage controller 23 so that the storage controller 23 and power supply control circuit 24 described in the first embodiment are integrally configured using one IC chip.

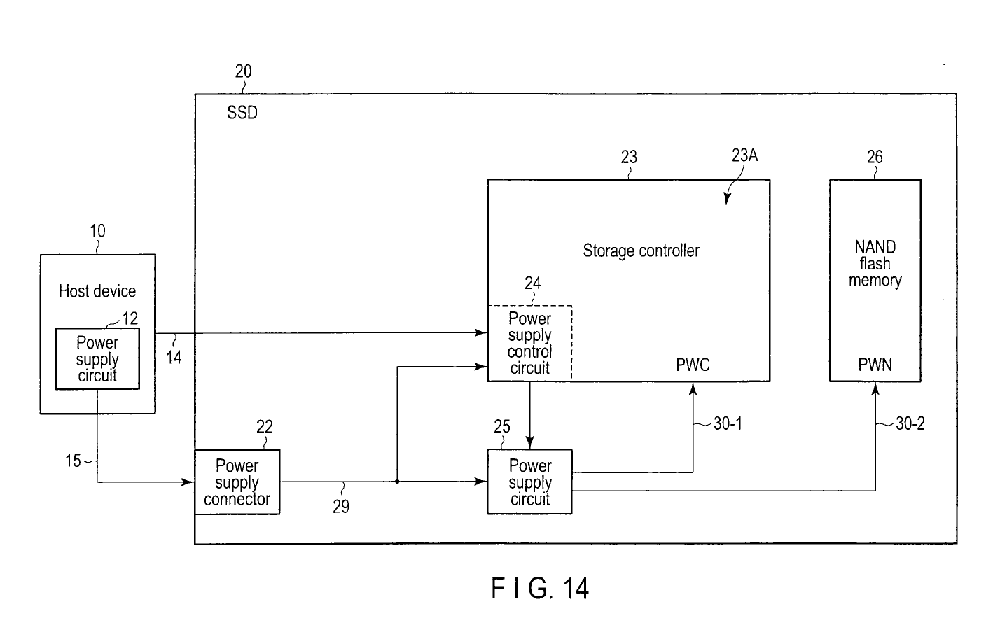

FIG. 14 is a block diagram of the SSD 20 according to the second embodiment. As shown in FIG. 14, the power supply control circuit 24 is incorporated into the storage controller 23, and the storage controller 23 comprises the power supply control circuit 24 and a control section 23A that is responsible for performing control other than the control provided by the power supply control circuit 24. That is, the storage controller 23 is configured using one IC chip comprising the control section 23A and the power supply control circuit 24. The control section 23A performs the same operations as those of the storage controller 23 described in the first embodiment.

In the second mode, the control section 23A is powered off, but the power supply control circuit 24 needs to be powered on. Thus, the power supply is separated between the power supply control circuit 24, a part of the storage controller 23, and the control section 23A, the remaining part of the storage controller 23 (the power supply involves separate lines for the power supply control circuit 24 and the control section 23A). The power supply control circuit 24 is electrically connected to the power connector 22 via the power supply line 29 and also electrically connected to the host device 10 via signal line 14. Operations between the power supply control circuit 24 and the control section 23A in the second mode are the same as the operations between the power supply control circuit 24 and the storage controller 23 described in the first embodiment.

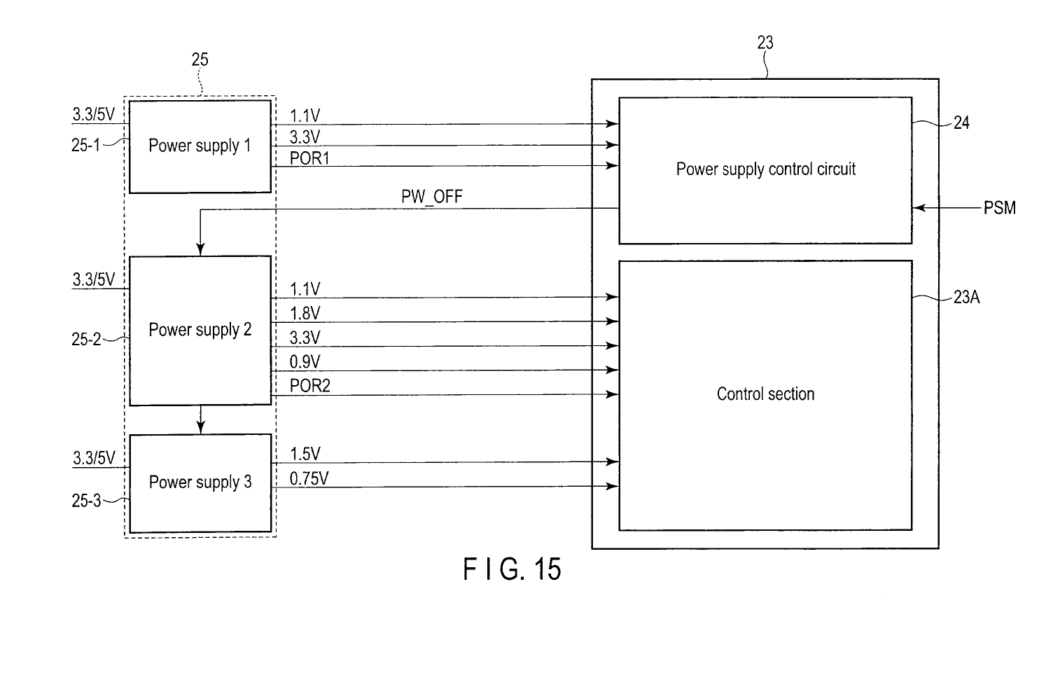

FIG. 15 a block diagram showing an example of configuration of the power supply circuit 25. The power supply circuit 25 comprises the first power supply (power supply 1) 25-1, the second power supply (power supply 2) 25-2, and the third power supply (power supply 3) 25-3. The first power supply 25-1 supplies different levels of power and a power-on reset signal POR1 to the power supply control circuit 24. The power supply control circuit 24 performs a reset operation in response to the power-on reset signal POR1. The second power supply 25-2 supplies different levels of power and a power-on reset signal. POR2 to the control section 23A. The control section 23A performs a reset operation in response to the power-on reset signal POR2. The third power supply 25-3 supplies power for the DRAM to the control section 23A.

The second embodiment can add the functions of the power supply control circuit 24 described in the first embodiment to the storage controller 23. Thus, in spite of the separate IC chip prepared for the power supply control circuit 24, the same function as those provided in the first embodiment can be implemented at low manufacturing costs.

### Third Embodiment

A second mode entry request and a second mode return request are sent from the host device 10 to the SSD 20 via the signal line. However, in such a configuration, noise may occur on the signal line. If the power supply control circuit 24 receives a request from the host device 10 every time noise occurs, the power supply control circuit 24 and the storage controller 23 may malfunction. Thus, according to a third embodiment, if the second mode entry request, sent from the host device 10 to the SSD 20, is not asserted continuously for a predetermined time or longer, the request is considered to suffer from noise on the signal line. Thus, the second mode is prevented from being entered.

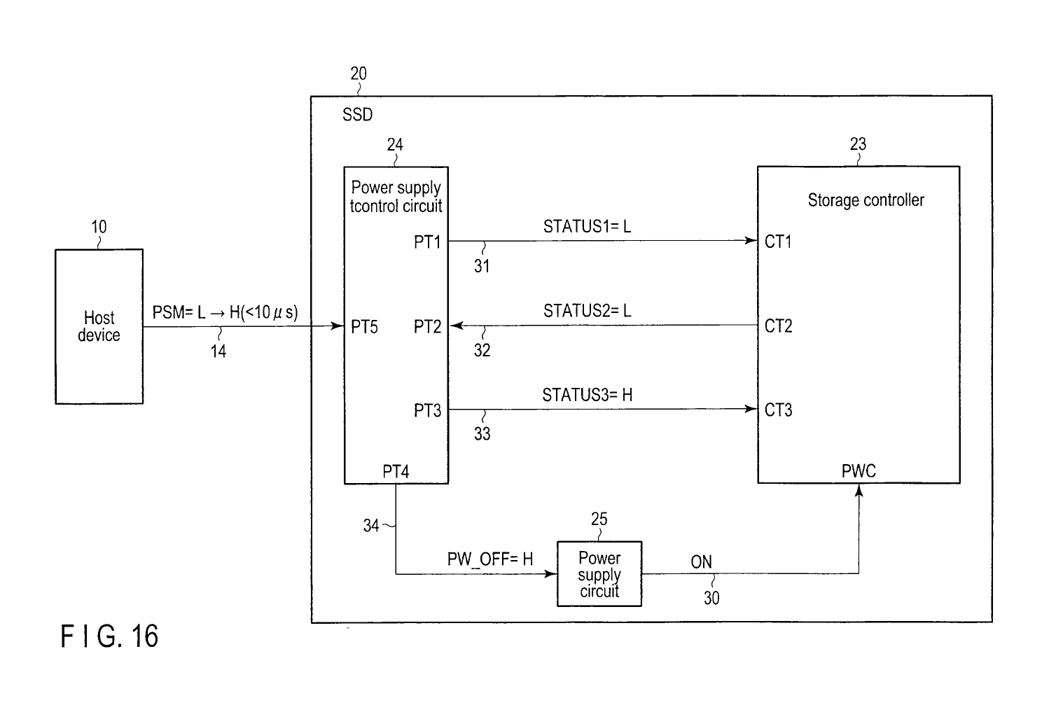

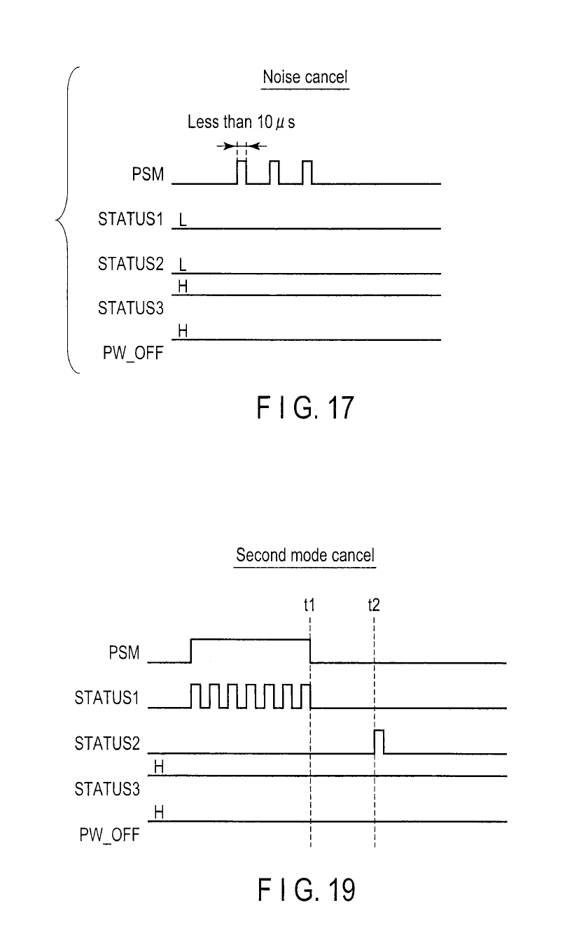

FIG. 16 is a diagram illustrating a noise cancel operation according to the third embodiment. FIG. 17 is a timing chart illustrating the noise cancel operation.

When the SSD 20 is in the first mode, signal PSM=Low, signal STATUS1=Low, signal STATUS2=Low, signal STATUS3=High, and signal PW_OFF=High. It is assumed that noise occurs on signal PSM, which thus changes to the high level for, for example, less than 10 μs. In this case, the power supply control circuit 24 avoids starting an operation for entering the second mode and maintains the signal status of the first mode. On the other hand, if signal PSM remains at the high level for 10 μs or more, the power supply control circuit 24 starts the operation for entering the second mode.

Similarly, also for an operation of returning from the second mode, if signal PSM changes to the low level for, for example, less than 10 μs, the power supply control circuit 24 avoids starting the operation for returning from the second mode.

The time for determination for possible noise on signal PSM is not limited to 10 μs but may be set to any time.

According to the third embodiment, if noise occurs on signal line 14 connecting the host device 10 and the power supply control circuit 24 together, the SSD 20 can be prevented from starting the operation of entering the second not or from starting the operation of returning from the second mode. This allows the SSD 20 to be prevented from malfunctioning as a result of noise.

### Fourth Embodiment

According to a fourth embodiment, if a second mode entry request from the host device 10 is canceled before the storage controller 23 executes a preparation process for entering the second mode, the power supply control circuit 24 prevents the storage controller 23 from being powered off.

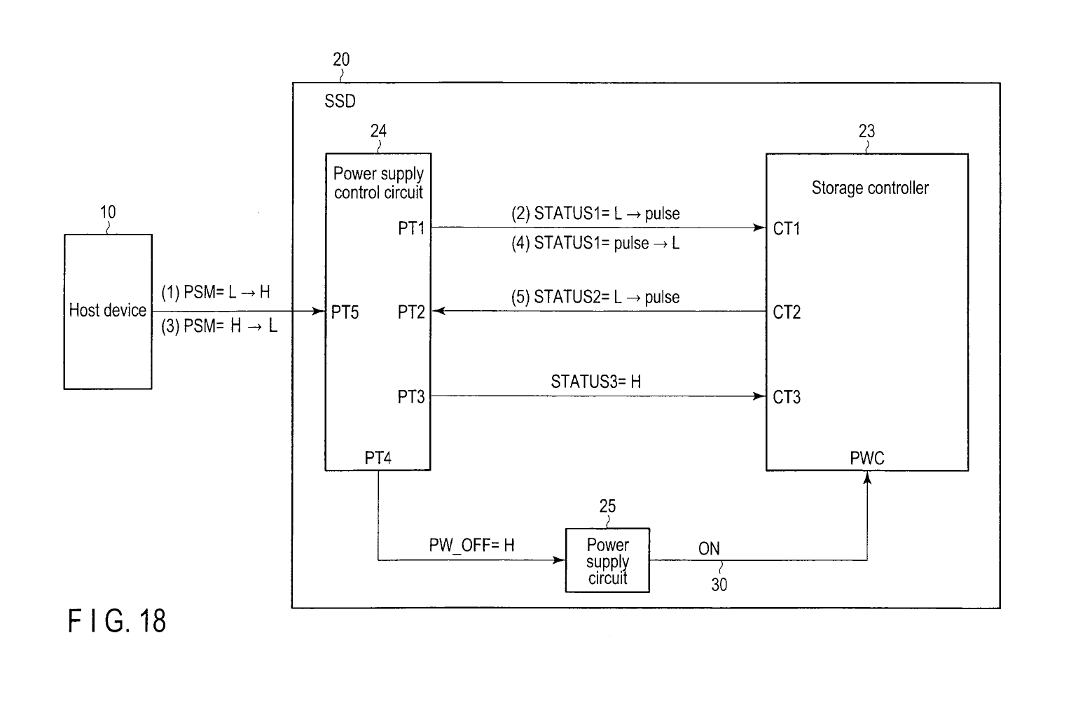

FIG. 18 is a diagram illustrating an operation of cancelling the second mode according to the fourth embodiment. FIG. 19 is a timing chart illustrating the operation of cancelling the second mode. First, the host device 10 sets signal PSM to the high level in order to enter the second mode.

In response to signal PSM at the high level, the power supply control circuit 24 outputs a continuous pulse as signal STATUS1. In response to signal STATUS1 comprising the continuous pulse, the storage controller 23 starts a preparation process for power-off (power supply disconnection).

It is assumed that signal PSM from the host device 10 subsequently changes to the low level (the second mode is cancelled). In response to signal PSM at the low level, the power supply control circuit 24 sets signal STATUS1 to the low level. In response to signal STATUS1 at the low level, the storage controller 23 stops (cancels) the preparation process for power-off. Furthermore, the power supply control circuit 24 keeps both signal STATUS3 and signal PW_OFF at the high level. This prevents the power supply circuit 25 from powering off the storage controller 23.

That is, as shown in FIG. 19, it is assumed that signal PSM changes to the low level at time t1 and that a pulse indicating that the storage controller 23 has completed the preparation process for power-off is output as signal STATUS2 at time t2. That is, if time t1 is earlier than time t2, the power supply control circuit 24 and the power supply circuit 25 avoid powering off the storage controller 23. On the other hand, if time t1 is later than time t2, the power supply circuit 25 powers off the storage controller 23.

According to the fourth embodiment, if the host device 10 issues and then cancels a second mode entry request, the storage controller 23 can be prevented from being powered off on the condition that the storage controller 23 has not completed preparation process for power-off. This enables the storage controller 23 from being repeatedly powered on and off. Furthermore, if the second mode is cancelled before completion, volatile data managed by the storage controller 23 can be prevented from being lost.

### Fifth Embodiment

The host device 10 comprising, for example, a personal computer has a third mode (sleep mode). If the host device 10 enters the third mode, the power consumption of the host device 10 can be reduced by setting the SSD 20 to the second mode. The fifth embodiment allows the SSD 20 to enter the second mode before the host device 10 enters the third mode.

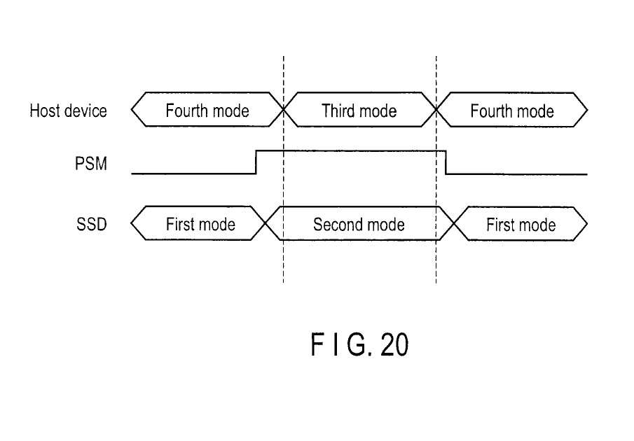

FIG. 20 is a timing chart illustrating a third mode operation of the host device 10 according to the fifth embodiment. The host device 10 is assumed to comprise, for example, a personal computer, and to have the third mode. Before changing from a fourth mode (normal mode or active mode) to the third mode, the host device 10 controls the SSD 20 so that the SSD 20 enters the second mode. Thus, the host device 10 sets signal PSM to the high level before entering the third mode.

In response to signal PSM at the high level, the SSD 20 performs an operation of entering the second mode as described above. Thus, the SSD 20 enters the second mode. Subsequently, the host device 10 enters the third mode.

Furthermore, after returning from the third mode to the fourth mode, the host device 10 controls the SSD 20 so that the SSD 20 returns from the second mode to the first mode. Thus, after returning to the fourth mode, the host device 10 sets signal PSM to the low level. In response to signal PSM at the low level, the SSD 20 performs an operation of returning from the second mode as described above. Thus, the SSD 20 enters the first mode.

The fifth embodiment can optimally link the third mode of the host device 10 with the second mode of the SSD 20. Furthermore, the SSD 20 can be set to be in the second mode while the host device 10 is in the third mode. This enables a reduction in the power consumption of the host device 10.

### Sixth Embodiment

A sixth embodiment is an example of configuration of the host device 10. The host device 10 can be configured using a personal computer.

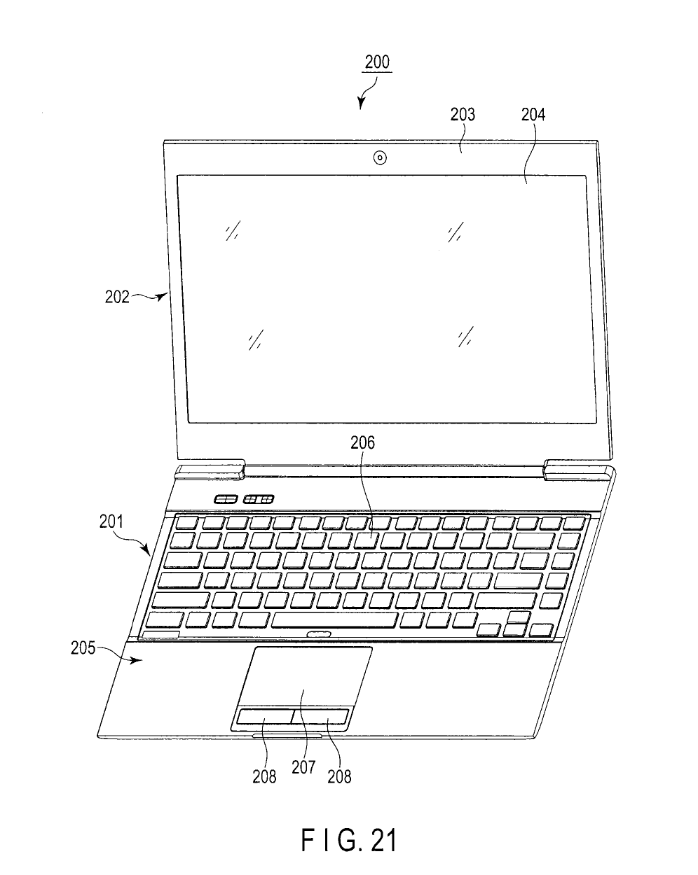

FIG. 21 is a perspective view showing an example of a personal computer 200 with the SSD 20 according to the above-described embodiments mounted therein. The personal computer 200 (for example, a notebook portable computer) comprises a main body 201 and a display unit 202. The display unit 202 comprises a display housing 203 and a display device 204 contained in the display housing 203.

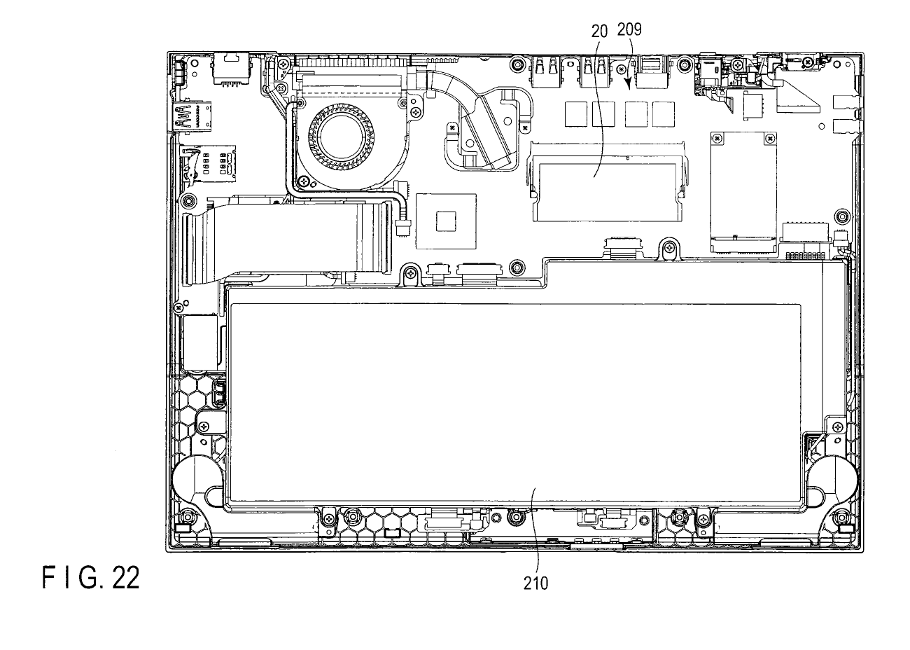

The main body 201 comprises a housing 205, a keyboard 206, a touchpad 207 serving as a pointing device, and a button 208 (touchpad button). FIG. 22 is a bottom view showing the interior of the main body 201. The housing 205 contains a main circuit substrate 209, the SSD 20, and a battery unit 210.

The SSD 20 may be mounted inside the personal computer 200 as an alternative to a conventional HDD or used as an additional device connected to an interface provided in the personal computer 200.

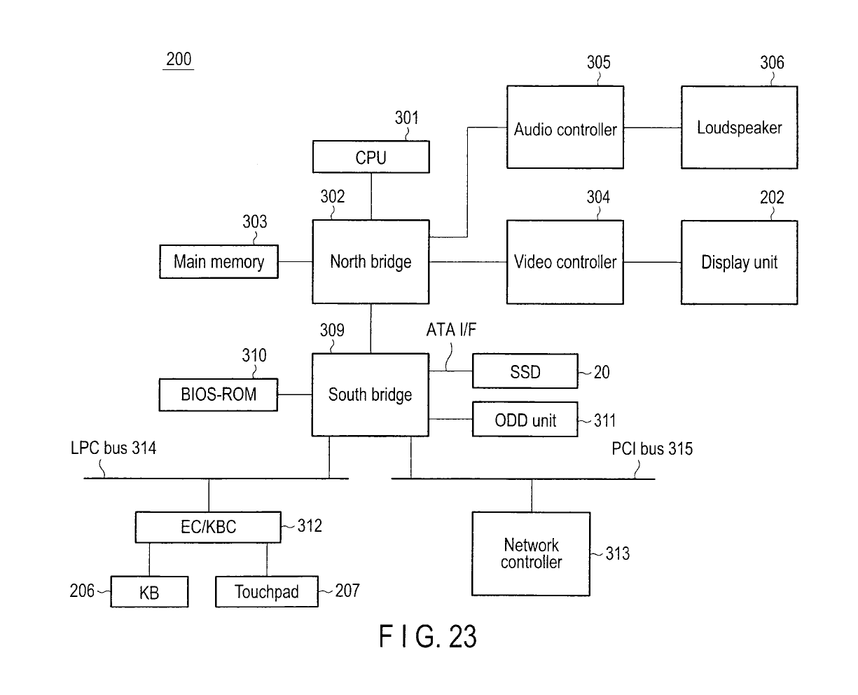

FIG. 23 is a block diagram showing an example of a system configuration of the personal computer 200. The personal computer 200 comprises a CPU 301, a north bridge 302, a main memory 303, a video controller 304, an audio controller 305, a south bridge 309, a BIOS-ROM 310, the SSD 20, an optical disk device (ODD) unit 311, an embedded controller/keyboard controller IC (EC/KBC) 312, and a network controller 313.

The CPU 301 is a processor provided to control the operation of the personal computer 200 and executes an operating system (OS) that is loaded from the SSD 20 into the main memory 303. Moreover, if the ODD unit 311 enables at least one of a read process and a write process to be carried out on an optical disk installed in the ODD unit 311, the CPU 301 carries out the process. The CPU 301 also executes a basic input/output system (system BIOS) stored in the BIOS-ROM 310. The system BIOS is a program for controlling hardware in the personal computer 200.

The north bridge 302 is a bridge device that connects a local bus for the CPU 301 to the south bridge 309. The north bridge 302 also comprises a built-in memory controller that controls accesses to the main memory 303. The north bridge 302 also has functions to communicate with the video controller 304 via an Accelerated Graphics Port (AGP) bus 314 and to communicate with the audio controller 305.

The main memory 303 is configured to temporarily store programs and data and functions as a work area for the CPU 301. The main memory 303 is configured using, for example, a RAM.

The video controller 304 is a video reproduction controller that controls the display unit 202, used as a display monitor for the personal computer 200. The audio controller 305 is an audio reproduction controller that controls a loudspeaker 306 for the personal computer 200.

The south bridge 309 controls, for example, devices on a Low Pin Count (LPC) bus and, for example, devices on a Peripheral Component Interconnect (PCI) bus 315. Furthermore, the south bridge 309 controls, via the ATA interface, the SSD 20, which is a storage device configured to store various types of software and data. The personal computer 200 accesses the SSD 20 in units of sectors. A write command, a read command, a cache flash command, and the like are input to the SSD 20. Furthermore, the south bridge 309 has a function to control accesses to the BIOS-ROM 310 and the ODD unit 311.

The EC/KBC 312 is a single-chip microcomputer in which an embedded controller for power management and a keyboard controller for controlling the keyboard (KB) 206 and the touchpad 207 are integrated together. The EC/KBC 312 has a function to power on and off the personal computer 200 in accordance with the user's operation of a power button. The network controller 313 is a communication device that communicates with an external network, for example, the Internet.

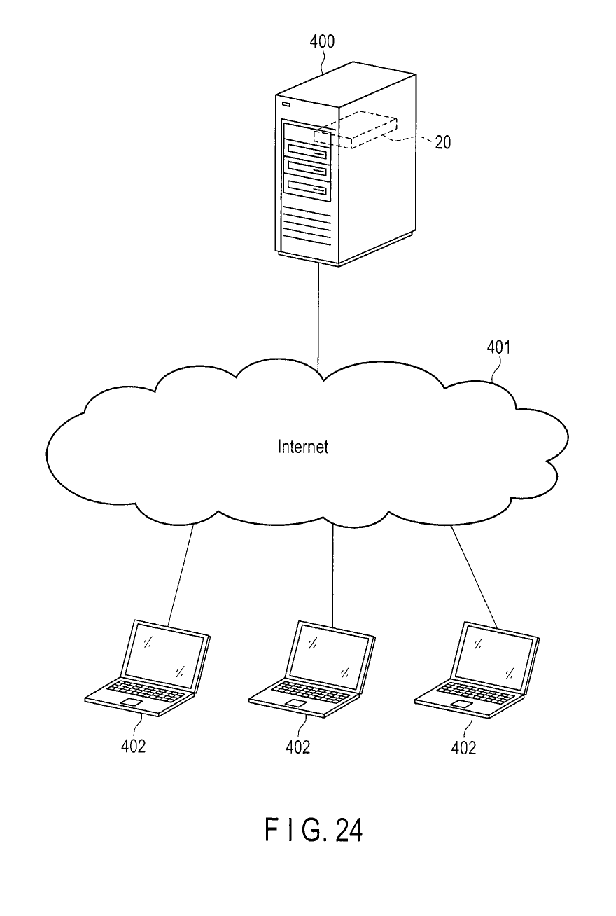

Furthermore, the host device 10 can be configured using a server connected to a network. FIG. 24 is a schematic diagram showing a server 400 with the SSD 20 mounted therein.

The server 400 internally comprises the SSD 20 for data storage. The server 400 is connected to a network 401 (for example, the Internet). Besides the server 400, a plurality of clients 402 (personal computers) providing information and functions for the server 400 is connected to the network 401.

The server 400 provides files and data stored in the SSD 20 to the clients 402 and also provides functions of the server 400 itself to the clients 402.

The embodiments have been described taking the SSD comprising a NAND flash memory as an example. However, the embodiments are not limited to this but are applicable to other storage devices such as a memory card with a NAND flash memory mounted therein.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system comprising:
a nonvolatile memory;
a controller configured to control an operation of the nonvolatile memory;
a connector electrically connected to a host device;
a power supply circuit configured to electrically connect the connector to the controller and the nonvolatile memory; and
a power supply control circuit electrically connected to the connector and configured to control an operation of the power supply circuit in response to a first request sent from the host device,
wherein the power supply control circuit sends a second request to the controller in response to the first request,
the controller writes management information for management of the nonvolatile memory to the nonvolatile memory in response to the second request and then sends a first signal to the power supply control circuit,
the power supply control circuit sends a third request to the power supply circuit in response to the first signal, and
the power supply circuit cuts power supplies to the controller and the nonvolatile memory in response to the third request.

2. The system of claim 1, wherein
the power supply control circuit sends a fifth request to the power supply circuit in response to a fourth request sent from the host device, and
the power supply circuit supplies power to the controller and the nonvolatile memory in response to the fifth request.

3. The system of claim 1, wherein the controller reads the management information from the nonvolatile memory after the controller is supplied with power from the power supply circuit.

4. The system of claim 1, wherein the power supply control circuit cancels the first request if the first request is not asserted continuously for a predetermined time or longer.

5. The system of claim 2, wherein the power supply control circuit sends a signal indicating whether a power supply responds to the fourth request or is used to activate the memory system, to the controller.

6. The system of claim 1, wherein the power supply control circuit is incorporated into an identical chip into which the controller is incorporated.

7. The system of claim 1, further comprising a dedicated signal line electrically connecting the host device and the power supply control circuit to transfer the first request.

8. The system of claim 1, wherein the nonvolatile memory is a NAND flash memory.

9. A memory system comprising:
a nonvolatile memory;
a controller configured to control an operation of the nonvolatile memory;
a power supply circuit configured to electrically connect a host device to the controller and the nonvolatile memory; and
a power supply control circuit electrically connected to the host device and configured to control an operation of the power supply circuit in response to a first request sent from the host device,
wherein the power supply control circuit sends a second request to the power supply circuit in response to the first request, and
the power supply circuit cuts power supplies to the controller and the nonvolatile memory in response to the second request.

10. The system of claim 9, wherein
the power supply control circuit sends a third request to the controller before cutting the power supply to the controller, and
the controller executes a preparation process for cutting the power supply in response to the third request.

11. The system of claim 10, wherein the controller sends a signal permitting the power supply to be cut, to the power supply control circuit after receiving the third request.

12. The system of claim 9, wherein
the power supply control circuit sends a fifth request to the power supply circuit in response to a fourth request sent from the host device, and
the power supply circuit supplies power to the controller and the nonvolatile memory in response to the fifth request.

13. The system of claim 12, wherein the power supply control circuit sends a signal indicating whether a power supply responds to the fourth request or is used to activate the memory system, to the controller.

14. The system of claim 9, wherein the power supply control circuit cancels the first request if the first request is not asserted continuously for a predetermined time or longer.

15. The system of claim 9, wherein the power supply control circuit is incorporated into an identical chip into which the controller is incorporated.

16. The system of claim 9, further comprising a dedicated signal line electrically connecting the host device and the power supply control circuit to transfer the first request.

17. The system of claim 9, further comprising a connector electrically connecting the host device to the power supply circuit.

18. The system of claim 9, wherein the nonvolatile memory is a NAND flash memory.

19. A memory system comprising:
a nonvolatile memory; and
a controller configured to control an operation of the nonvolatile memory,
wherein when the memory system receives a first request from a host device, a power supply to the controller is cut.

20. The system of claim 19, wherein when the memory system receives the first request, a power supply to the nonvolatile memory is cut.
